(19) United States
(12) Patent Application Publication
(10) Pub. No.: US 2005/0289634 A1
(43) Pub. Date: Dec. 29, 2005

(54) Image service system

(75) Inventors: Akira Yoda, Kanagawa-ken (JP); Makoto Hara, Kanagawa-ken (JP); Syuji Ono, Kanagawa-ken (JP); Koji Wada, Tokyo (JP); Hajime Araya, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/136,727

(22) Filed: May 25, 2005

(30) Foreign Application Priority Data
May 25, 2004 (JP) 2004-154094

(51) Int. Cl. H04N 7/173; H04N 7/16

(52) U.S. Cl. 725/134; 725/115; 725/116; 725/93; 725/142

(57) ABSTRACT

Illegal use of a playlist can be prevented. A laboratory generates a playlist and encodes the playlist with a public key. The encoded playlist is recorded in a DVD. When a user carries out reproduction using the playlist on a personal computer, the personal computer compares token information thereof and token information included in an access ticket issued by an access ticket issuing center according to the token information of the personal computer. The personal computer carries out the reproduction by decoding the playlist with the private key in the access ticket only in the case where the token information thereof agrees with the token information in the access ticket.

### BACKGROUND OF THE INVENTION

1. Field of the Invention

The present invention relates to an image service system. More specifically, the present invention relates to an image service system for providing a user with a playlist that defines a manner of reproduction of image data sets.

2. Description of the Related Art

A photograph service system has been proposed in Japanese Unexamined Patent Publications No. 10(1998)-150538 or 10(1998)-150541, for example. In such a system, images recorded on a negative film or prints are read by a reading apparatus such as a scanner for obtaining image data sets. The image data sets are stored in a recording medium such as a CD-R, and reproduced by a reproduction apparatus such as a personal computer for appreciation thereof. Furthermore, the image data sets are printed at the request of a user. In addition, a network photograph service system including an image storage system has also been proposed in Japanese Unexamined Patent Publication No. 11(1999)-154218, for example. In the network photograph service system, image data sets are sent to and stored in an image storage server via a network such as the Internet, and various kinds of processing regarding the image data sets, such as viewing the image data sets and placing a printing order, can be carried out by use of a terminal remote from the image storage server.

However, in the image storage system described above, images are read from a negative film at the same time as the images are printed immediately after development of the film. Therefore, image data sets are stored collectively for each roll of film. Consequently, correlating a user who requested storage of the image data sets to the film roll is a troublesome task. In addition, images are only read from a negative film and stored thereafter. Therefore, a large amount of image data sets are simply stored without being set in order if images are read from prints or negative films, which had been neglected in a household. In this case, a user who accesses the image storage server needs to set the image data sets in order, which is as troublesome as in the case of classification of the prints and the negative films. Therefore, such a system is not convenient.

For this reason, a so-called “photo mining” service system has been proposed in U.S. patent application Publication No. 20030151767, for example. In this system, image data sets are obtained from recording media such as prints and negative films, and related to recording media information representing the recording media from which the image data sets have been obtained. The image data sets related to the recording media information are then stored for each user, based on user information. In this system, if a user only requests image reading from a DPE store although a large amount of prints and negative films neglected in his/her household have not been set in order, the user can view image data sets obtained through the image reading in a state wherein the image data sets are classified according to the recording media information.

This system is applicable not only to image data sets obtained by image reading from films or prints but also to image data sets obtained by photography with a digital camera, for example.

By using the system described in U.S. patent application Publication No. 20030151767, image data sets of a user can be recorded in a recording medium such as a DVD-R and provided to the user. At this time, an image data set enabling reproduction of the image data sets in a predetermined format such as a slide show can be generated and recorded together with the image data sets. In this manner, the user can enjoy the slide show by using a reproduction apparatus such as his/her personal computer or DVD player.

Meanwhile, in Japanese Unexamined Patent Publication No. 2001-103415, a method has been proposed for generating a sequence table defining reproduction order of image data sets in a slide show and for reproducing the image data sets in the order defined by the sequence table. This method may be applied to the system described in U.S. patent application Publication No. 20030151767. More specifically, instead of generating a new image data set in a predetermined reproduction format such as a slide show that uses image data sets, a so-called “playlist” that defines a manner of reproduction of the image data sets maybe generated for reproduction of the image data sets in the format and recorded in a recording medium together with the image data sets. Like the sequence table in Japanese Unexamined Patent Publication No. 2001-103415, this playlist may only define reproduction order of the image data sets. However, if the playlist also defines the manner of reproduction in addition to the reproduction order, such as duration of reproduction of each of the image data sets and where each of the image data sets are reproduced in a screen, the image data sets can be reproduced in various manners. Therefore, a user can enjoy the image data sets reproduced on a reproduction apparatus in the manner defined by the playlist. At the same time, a service provider can save time on generating the recording medium and also conserve space in the recording medium, which is efficient.

The playlist can be generated for reproducing only a part of the image data sets requested by the user, or judged to be important (such as image data sets of high quality), in the form of slide show, instead of reproducing all of the image data sets recorded in the recording medium. In this manner, a compilation slide show of “people” or “journey” or the like can be generated for reproducing only image data sets of people or image data sets obtained during a predetermined trip, which enables provision of a better service to the user.

In addition, the user may also be provided with audio data sets, template data sets representing frames or the like, and moving image data sets representing characters or the like recorded in the recording medium for free or for a charge, in addition to the image data sets. In this case, if the playlist is generated for enabling reproduction of the audio data sets used as background music and the template data sets or the moving image data sets used together with the image data sets, the slide show can be appreciated more.

Furthermore, templates of playlists may be generated in advance so that the user may be provided with the playlist, generated by editing one of the templates according to his/her image data sets. In this manner, efficiency of playlist generation can be improved.

By generating the playlist that defines the manner of reproduction of the image data sets and by providing the playlist to the user, the user can be provided with various kinds of services.

However, if the playlist is provided to the user, the user may illegally use the playlist. For example, the user may apply the playlist to other image data sets through alteration of the playlist, or may provide the playlist to a third person. The service provider who generated the playlist cannot charge for the playlist that has been used illegally, and sustains a loss.

### SUMMARY OF THE INVENTION

The present invention has been conceived based on consideration of the above circumstances. An object of the present invention is therefore to provide an image service system that enables improvement in various services by providing a playlist to a user and prevents illegal use of the playlist.

An image service system of the present invention comprises a playlist generation apparatus, an access information generation apparatus, and a reproduction apparatus. The playlist generation apparatus comprises:

a playlist generation unit for generating a playlist that defines a manner of reproduction of image data sets;

an encoding unit for obtaining an encoded playlist by encoding the playlist; and

an output unit for outputting the encoded playlist. The access information generation apparatus comprises:

specific information acquisition means for obtaining specific information to be possessed by a reproduction apparatus having access to the playlist; and

an access information generation unit for generating access information including the specific information and a private key for decoding the playlist. The reproduction apparatus comprises:

a storage unit for storing specific information for the reproduction apparatus;

a decoding unit for comparing the specific information included in the access information with the specific information stored in the storage unit when an instruction for the reproduction using the playlist is input to the reproduction apparatus, and for outputting the playlist to a temporary storage unit of the reproduction apparatus by decoding the playlist by use of the private key included in the access information in the case where the specific information in the access information agrees with the specific information stored in the storage unit; and

a reproduction unit for carrying out the reproduction of the image data sets in the manner defined by the playlist by using the playlist output to the temporary storage unit.

It is preferable for the reproduction apparatus to further comprise a playlist protection unit for deleting the decoded playlist from the temporary storage unit after the reproduction has been completed.

The output unit of the playlist generation apparatus outputs the encoded playlist according to a manner of provision of the encoded playlist to a user. For example, in the case where the playlist is provide to the user by being recorded in a recording medium such as a DVD, the output unit records the encoded playlist in the recording medium.

The playlist generation unit of the playlist generation apparatus of the present invention preferably generates a simplified playlist by simplifying the playlist. In this case, it is preferable for the output unit to record the simplified playlist together with the encoded playlist in the recording medium.

Furthermore, it is preferable for the playlist generation apparatus to further comprise a video data generation unit for generating video data enabling reproduction of the image data sets in the manner defined by the playlist, by using the image data sets. In this case, the output unit preferably records the video data in the recording medium.

According to the image service system of the present invention, the encoded playlist obtained by encoding the playlist and the access information corresponding to the playlist are provided to the user. When the user carries out the reproduction using the playlist on the reproduction apparatus, the decoding unit in the reproduction apparatus compares the specific information for the reproduction apparatus with the specific information included in the access information that is to be possessed by the reproduction apparatus having the access to the playlist. The decoding unit decodes the encoded playlist by use of the private key in the access information, only in the case where the specific information for the reproduction apparatus agrees with the specific information included in the access information. The decoding unit then outputs the decoded playlist to the temporary storage unit such as a memory of the reproduction apparatus, and the reproduction unit of the reproduction apparatus carries out the reproduction by using the playlist output to the temporary storage unit. In this manner, the decoded playlist can be stored only in the temporary storage unit, and illegal use of the decoded playlist, such as alteration thereof or copying thereof, can be prevented. Furthermore, the encoded playlist can be decoded only by the reproduction apparatus having the specific information included in the access information. Therefore, although the playlist can be read by another reproduction apparatus such as a personal computer, the encoded playlist cannot be used by the reproduction apparatus that does not have the specific information.

In addition, the playlist can be used more securely if the reproduction apparatus has the playlist protection unit for deleting the playlist in the temporary storage unit after completion of the reproduction, although the playlist output to the temporary storage unit is automatically deleted when power supply to the reproduction apparatus is cut or when the temporary storage unit is used by other processing.

If the simplified playlist can be provided to the user by being recorded in the recording medium such as a DVD together with the encoded playlist and if the simplified playlist is free of charge, the user can decide whether he/she will purchase the access information to the encoded playlist for using the playlist, after reproduction using the simplified playlist.

In the case where the video data are generated by using the image data sets in the manner defined by the playlist and provided to the user together with the encoded playlist, although the user can carry out the reproduction only on the reproduction apparatus having the access to the playlist, the user can also enjoy the video data in a slightly lower image quality by using a DVD player or the like, which is convenient.

### BRIEF DESCRIPTION OF THE DRAWINGS

FIG. 1 is a block diagram showing the configuration of an image service system of an embodiment of the present invention;

FIG. 2 is a block diagram showing the configuration of a laboratory 50 in the image service system;

FIG. 3 shows the content of data recorded in a recording medium to be provided to a user;

FIG. 4 is a block diagram showing the configuration of an access ticket issuing center 100 in the image service system; and

FIG. 5 is a block diagram showing the configuration of a personal computer 150 in the image service system.

### DESCRIPTION OF THE PREFERRED EMBODIMENT

Hereinafter, an embodiment of the present invention will be described with reference to the accompanying drawings.

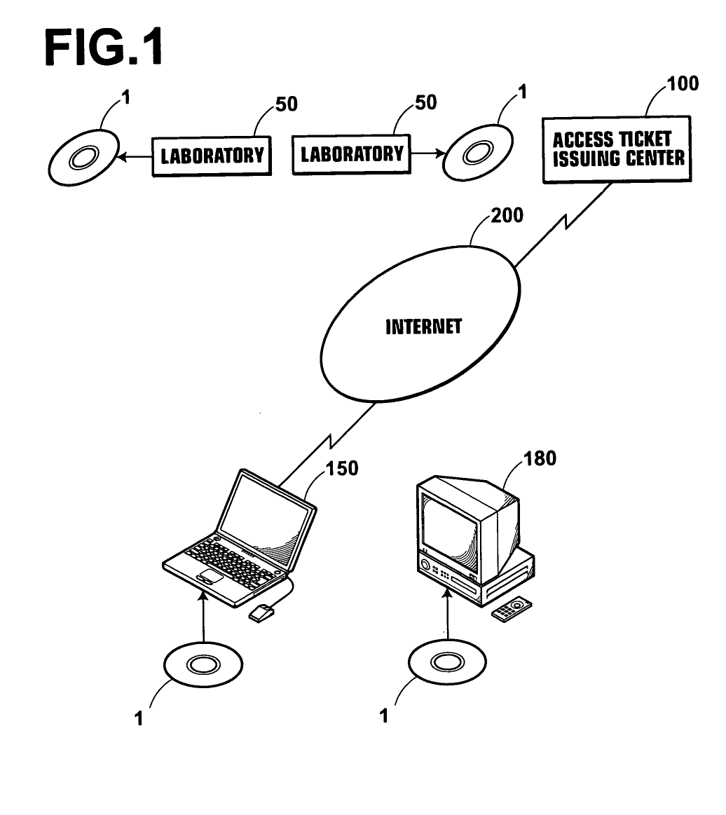

FIG. 1 is a block diagram showing the configuration of an image service system of an embodiment of the present invention. As shown in FIG. 1, the image service system comprises a plurality of laboratories 50 for providing a user with a recording medium such as a DVD 1 by recording image data sets of the user in the recording medium upon request of the user, an access ticket issuing center 100, and reproduction apparatuses such as a personal computer 150 and a DVD player 180 by which the user can enjoy the image data sets recorded in the DVD 1. The personal computer 150 and the access ticket issuing center 100 are communicable with each other via the Internet 200.

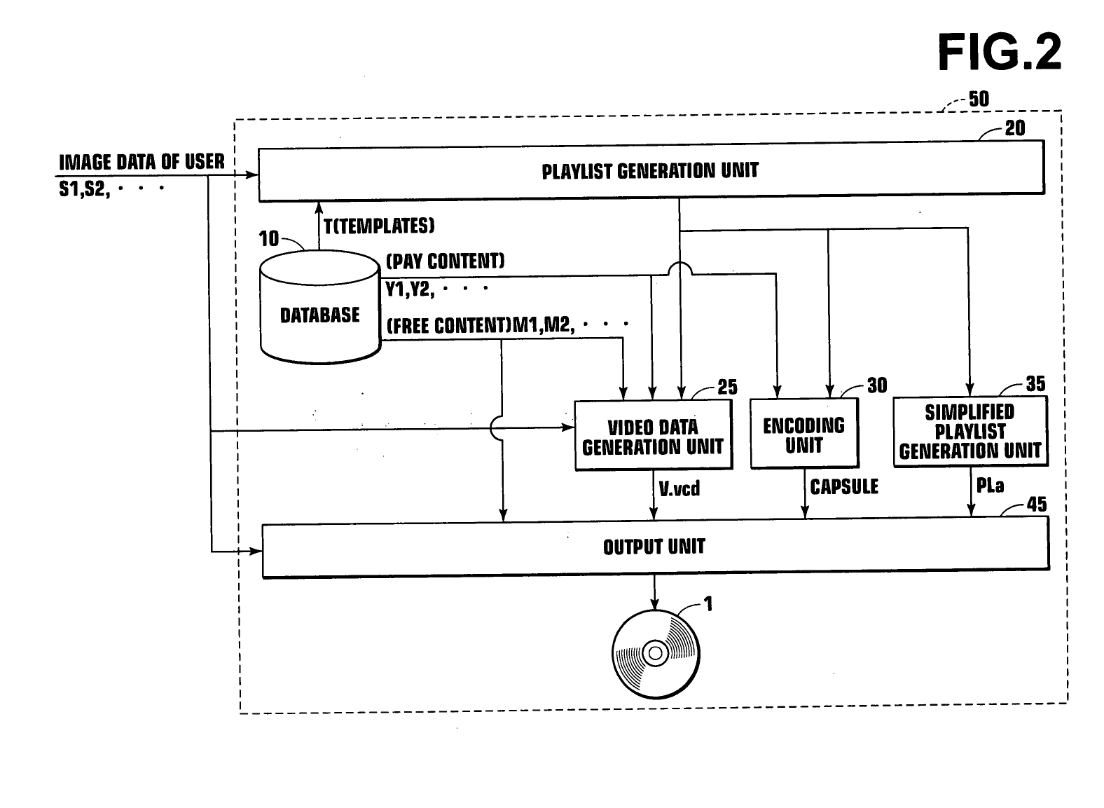

FIG. 2 shows the configuration of each of the laboratories 50. As shown in FIG. 2, the laboratory 50 comprises a database 10, a playlist generation unit 20, a video data generation unit 25, an encoding unit 30, a simplified playlist generation unit 35, and an output unit 45. Hereinafter, these units will be described in detail.

The playlist generation unit 20 generates a playlist PL for reproducing image data sets S (S1, S2, S3, and so on) of the user in a predetermined manner (a slide show, in this case). The playlist PL generated by the playlist generation unit 20 in this embodiment defines reproduction order of the image data sets S of the user, duration of reproduction of each of the image data sets S, a position of reproduction of each of the image data sets in a screen, image data sets to be reproduced together with or between the image data sets S of the user, audio data sets to be used as background music for the slide show, moving image data sets to add special effects to the slide show, and how the moving image data sets are reproduced. The data sets other than the image data sets S of the user can be pay content Y (Y1, Y2, Y3 and so on) and free content M (M1, M2, M3, and so on). The pay content and the free content are stored in the database 10. Some of the image data sets S of the user which are not listed in the playlist PL are not reproduced in the slide show.

The database 10 also stores a plurality of templates T to be provided to the playlist generation unit 20. The templates T are used as common forms of playlists of various kinds, such as trips, people, and birth of a new baby. The playlist generation unit 20 reads an appropriate one of the templates T from the database 10, and edits the template for generating the playlist PL corresponding to the image data sets S of the user.

The playlist generation unit 20 outputs the playlist PL to the video data generation unit 25, the encoding unit 30, and the simplified playlist generation unit 35.

The video data generation unit 25 generates a video data set V.vcd which enables reproduction of the data specified by the playlist PL (the image data sets S of the user, the pay content Y, and the free content M) in the manner specified by the playlist PL.

The encoding unit 30 obtains a capsule by encoding the playlist PL and the pay content Y specified by the playlist PL. Methods of encoding are largely classified into common key methods and public key methods. In a common key method, the same private key is used for encoding and decoding. In a public key method, a public key and a private key are respectively used for encoding and decoding or vise versa. In this embodiment, the encoding unit 30 uses a public key to encode the playlist PL and the pay content Y.

The simplified playlist generation unit 35 generates a simplified playlist PLa as a simplified version of the playlist PL using only the image data sets S of the user and the free content M, by editing the playlist PL.

The video data set V.vcd generated by the video data generation unit 25, the capsule obtained by the encoding unit 30, and the simplified playlist PLa generated by the simplified playlist generation unit 35 are output to the output unit 45.

The output unit 45 records in the DVD 1 the image data sets S of the user, the video data set V.vcd, the capsule, the simplified playlist PLa and the free content M in the case where the playlist PL and the simplified playlist PLa have specified the free content M.

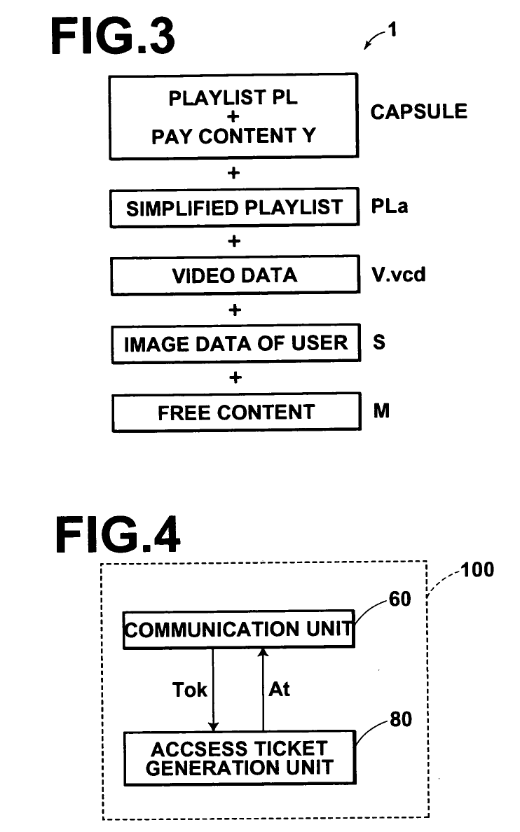

FIG. 3 shows how the data are recorded in the DVD 1. As shown in FIG. 3, the DVD 1 has the capsule, the simplified playlist PLa, the video data set V.vcd, the image data sets S, and the free content M. The capsule surrounded by broken lines is obtained by encoding the playlist PL and the pay content Y.

The DVD 1 generated by any one of the laboratories 50 is provided to the user by being mailed or handed to the user at a store. Although not shown, the laboratory 50 also charges the user for a fee for generation of the DVD 1 (including a charge for the pay content Y). In this embodiment, a fee for using the playlist PL is not charged at the time the user is provided with the DVD 1.

FIG. 4 shows the configuration of the access ticket issuing center 100. As shown in FIG. 4, the access ticket issuing center 100 comprises a communication unit 60 for communicating with the personal computer 150 via the Internet 200, and an access ticket generation unit 80.

The communication unit 60 of the access ticket issuing center 100 shown in FIG. 4 receives characteristics information Tok of a token (hereinafter simply referred to as token information which will be described later) for the personal computer 150 of the user from the personal computer 150, and sends to the personal computer 150 an access ticket At generated by the access ticket generation unit 80 in response to reception of the token information.

The access ticket generation unit 80 refers to the token information Tok of the personal computer 150 received by the communication unit 60, and generates the access ticket At corresponding to the token information Tok. In combination with dedicated application software installed in the personal computer, the access ticket enables execution of decoding processing using the private key included in the access ticket only by the apparatus (the personal computer, in this case) having the token agreeing with the token information included in the access ticket, without letting the user of the apparatus know the private key. This technique is realized as DDSA (Digital Document Security Architecture) by Fuji Xerox Co., Ltd. The access ticket generation unit 80 in this embodiment generates the access ticket At including the private key for decoding the capsule (the encoded playlist and the encoded pay content) recorded in the DVD 1 and the token information Tok of the personal computer 150. The access ticket generation unit 80 sends the access ticket At to the personal computer 150 via the communication unit 60.

Although not shown, the access ticket issuing center 100 charges the user for a fee for issuing (generating and sending) the access ticket At. In other words, the user is charged for using the playlist PL on the personal computer having the token agreeing with the token information included in the access ticket At. Any method of charging may be used, and a detailed description thereof is omitted.

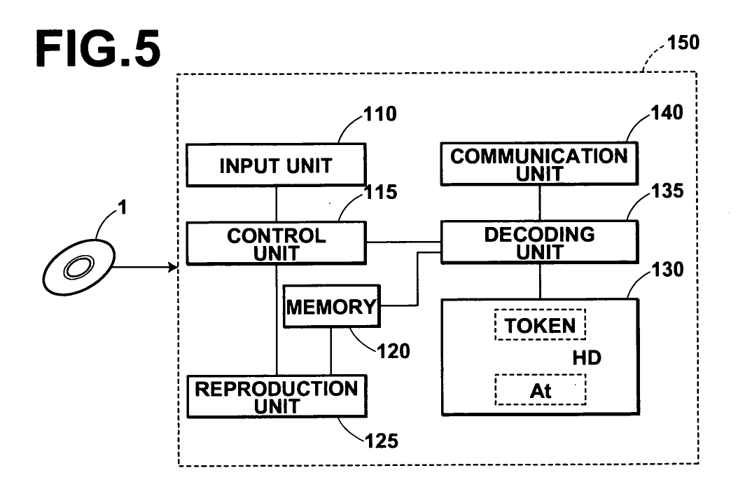

FIG. 5 is a block diagram showing the configuration of the personal computer 150. For the sake of simpler description, detailed description is omitted regarding the CPU that is indispensable for operation of the personal computer 150 and regarding a DVD drive for inputting the data in the DVD 1 to the personal computer 150.

As shown in FIG. 5, the personal computer 150 comprises an input unit 110 having a keyboard, a mouse, and the like used by the user for inputting various kinds of instructions to the personal computer 150, a control unit 115, a memory 120, a reproduction unit 125, a hard disc 130, a decoding unit 135, and a communication unit 140. The hard disc 130 stores the token installed in the personal computer 150. In the case where the access ticket At has been issued from the access ticket issuing center 100, the hard disc 130 also stores the access ticket At.

When the user instructs the personal computer 150 to reproduce the data in the DVD 1 by using the input unit 110, the control unit 115 confirms whether the playlist PL is necessary for reproduction of the data. In the case where the playlist PL is not necessary (such as the case where the image data sets S are reproduced one by one, or the case where the simplified playlist PLa is used for reproduction, or the case where the free content M is reproduced one by one, or the case where the video data set V.vcd is reproduced, for example), the control unit 115 causes the reproduction unit 125 to carry out the reproduction. In the case where the reproduction needs the playlist PL, the control unit 115 causes the decoding unit 135 to decode the capsule since the playlist PL has been encoded in the form of the capsule.

The decoding unit 135 is realized by installation of the dedicated application software for decoding the capsule. The dedicated application software may be recorded in the DVD 1 together with the data by the laboratory 50 and provided to the user. Alternatively, the software may be distributed as a supplement of a magazine, or via the Internet.

When the control unit 115 instructs the decoding unit 135 to decode the capsule, the decoding unit 135 confirms whether the access ticket At is stored in the hard disc 130. In the case where the hard disc 130 has the access ticket At, the decoding unit 135 decodes the capsule in the DVD 1 by using the access ticket At. More specifically, the decoding unit 135 sends a challenge to the token of the personal computer 150 and receives a response. The decoding unit 135 then compares a relationship between the challenge and the response with the token information Tok included in the access ticket At. The token information represents a mathematical relationship between the challenge and the response input to the token, and the token installed in the personal computer has the token information specific thereto. The decoding unit 135 judges whether the relationship between the challenge and the response agrees with the relationship represented by the token information included in the access ticket At. If the two relationships agree with each other, the decoding unit 135 decodes in the memory 120 the capsule recorded in the DVD 1 by using the private key included in the access ticket At. The control unit 115 causes the reproduction unit 125 to carry out the reproduction using the playlist PL in the memory 120 after the decoding unit 135 has decoded the capsule.

The decoding unit 135 sends information representing that decoding is not carried out to the control unit 115 in the case where the two relationships do not agree with each other, and completes the decoding processing.

In the case where the hard disc 130 does not have the access ticket At when the decoding instruction is received from the control unit 115, the decoding unit 135 sends the token information Tok of the personal computer 150 to the communication unit 140, and requests issuance of the access ticket At. The decoding unit 135 then decodes the capsule by using the access ticket At issued by the access ticket issuing center 100 in response to the request. The processing for decoding by use of the access ticket At is the same as the decoding processing using the access ticket At stored in the hard disc 130. Therefore, detailed description thereof is omitted. The decoding unit 135 uses the access ticket At issued by the access ticket issuing center 100 for decoding, and stores the access ticket At in the hard disc 130.

The reproduction unit 125 reads the data necessary for the reproduction from the DVD 1 under control of the control unit 115, in the case where the reproduction does not need the playlist PL. In the case where the reproduction needs the playlist PL, the reproduction unit 125 refers to the playlist PL in the memory 120, and reproduces the data specified by the playlist PL (such as the image data sets S of the user in the DVD 1, the free content M, and the pay content Y in the memory 120) according to the manner defined by the playlist PL.

After completion of the reproduction using the playlist PL, the decoding unit 135 deletes the decoded playlist PL and the decoded pay content Y in the memory 120. This deletion processing is carried out in the case where the reproduction has been completed normally, or in the case where the reproduction has been forcibly quit, or in the case where the reproduction is quit due to malfunctioning of the computer.

The reproduction using the playlist PL and the pay content Y can be carried out only by the specific reproduction apparatus, that is, only by the personal computer 150. However, reproduction using the video data set V.vcd and the simplified playlist PLa stored in the DVD 1 can be carried out by another reproduction apparatus.

Although the preferred embodiment of the present invention has been described above, the image service system of the present invention is not necessarily limited to the embodiment described above. Various modifications can be made thereto within the scope of the present invention.

For example, the access ticket At is issued when the user tries to carry out the reproduction using the playlist PL in this embodiment. However, the token information of the personal computer 150 of the user may be obtained in advance so that the access ticket corresponding to the token information can be generated. The access ticket is recorded in the recording medium in addition to the data shown in FIG. 3 and provided to the user. In this case, the user is charged for the fee for using the playlist and the pay content at the time the user is provided with the recording medium.

An ID (such as an ID comprising the identification number of the laboratory 50 that has generated the playlist PL, the identification number of the template T used for generating the playlist PL, and the production number in the laboratory 50) may also be added to the playlist to be provided to the user. The ID is embedded in the playlist by using an electronic watermark technique. In this manner, even in the case where the playlist has been used illegally, information that is useful for investigating a cause of illegal use, such as which of the laboratories 50 has generated the playlist and which of the templates T has been used for generating the playlist, can be obtained.

The user may be provided with the playlist in the form of the recording medium storing the playlist or by transmission of the playlist to the personal computer via a network, for example.

In this embodiment, the playlist and the pay content have been encoded by a public key. However, a public key method is more time-consuming than a common key method. Therefore, the playlist and the pay content may be encoded by a common key method so that the common key can be encoded by a public key. In this case, the access ticket includes a private key corresponding to the public key, and the common key is decoded by the private key in the access ticket upon the decoding processing. The playlist and the pay content are then decoded by the decoded common key. In this manner, time necessary for the processing can be shortened.

1. An image service system comprising a playlist generation apparatus, an access information generation apparatus, and a reproduction apparatus, the playlist generation apparatus comprising:
a playlist generation unit for generating a playlist defining a manner of reproduction of image data sets;
an encoding unit for obtaining an encoded playlist by encoding the playlist; and
an output unit for outputting the encoded playlist, the access information generation apparatus comprising:
specific information acquisition means for obtaining specific information to be possessed by a reproduction apparatus having access to the playlist; and
an access information generation unit for generating access information including the specific information and a private key for decoding the playlist, the reproduction apparatus comprising:
a storage unit for storing specific information for the reproduction apparatus;
a decoding unit for comparing the specific information included in the access information with the specific information stored in the storage unit when an instruction for the reproduction using the playlist is input to the reproduction apparatus, and for outputting the playlist to a temporary storage unit of the reproduction apparatus by decoding the playlist by use of the private key included in the access information in the case where the specific information in the access information agrees with the specific information stored in the storage unit; and
a reproduction unit for carrying out the reproduction of the image data sets in the manner defined by the playlist by using the playlist output to the temporary storage unit.

2. The image service system according to claim 1, wherein the reproduction apparatus further comprises a playlist protection unit for deleting the decoded playlist from the temporary storage unit after the reproduction has been completed.

3. The image service system according to claim 1, wherein the output unit records the encoded playlist in a recording medium provided to a user.

4. The image service system according to claim 2, wherein the output unit records the encoded playlist in a recording medium provided to a user.

5. The image service system according to claim 3, wherein the playlist generation unit generates a simplified playlist by simplifying the playlist, and
the output unit records the simplified playlist in the recording medium together with the encoded playlist.

6. The image service system according to claim 4, wherein the playlist generation unit generates a simplified playlist by simplifying the playlist, and
the output unit records the simplified playlist in the recording medium together with the encoded playlist.

7. The image service system according to claim 3, wherein the playlist generation apparatus further comprises a video data generation unit for generating video data enabling reproduction of the image data sets in the manner defined by the playlist by using the image data sets, and
the output unit also records the video data in the recording medium.

8. The image service system according to claim 4, wherein the playlist generation apparatus further comprises a video data generation unit for generating video data enabling reproduction of the image data sets in the manner defined by the playlist by using the image data sets, and
the output unit also records the video data in the recording medium.

9. The image service system according to claim 5, wherein the playlist generation apparatus further comprises a video data generation unit for generating video data enabling reproduction of the image data sets in the manner defined by the playlist by using the image data sets, and
the output unit also records the video data in the recording medium.

10. The image service system according to claim 6, wherein the playlist generation apparatus further comprises a video data generation unit for generating video data enabling reproduction of the image data sets in the manner defined by the playlist by using the image data sets, and
the output unit also records the video data in the recording medium.
